(19) United States
(12) Patent Application Publication
(10) Pub. No.: US 2007/0121462 A1
(43) Pub. Date: May 31, 2007

(54) Optical disc apparatus and information recording method

(76) Inventors: Toshiki Ishii, Tokyo (JP); Tsuyoshi Toda, Kodaira (JP); Tetsuya Fushimi, Tokyo (JP); Masashi Imai, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/488,617

(22) Filed: Jul. 19, 2006

(30) Foreign Application Priority Data
Nov. 29, 2005 (JP) 2005-343206

(51) Int. Cl. G11B 7/0045

(52) U.S. Cl. 369/59.11; 369/59.12

(57) ABSTRACT

To provide a technology for improving the recording quality through edge correction of recording pulse in an optical disc apparatus. An optimum recording power of recording pulse is obtained through OPC processing according to a recording strategy with a first pulse timing; recording is performed by use of recording pulse with the optimum recording power; a first edge-shift amount of recording mark is measured from a reproduction signal to perform edge correction of recording pulse to form a second pulse timing of a recording strategy. Subsequently, recording is performed with pulse width variations of recording pulse to measure a second edge-shift amount of recording mark from a reproduction signal; and optimum edge positions of recording pulse are calculated based on the first edge-shift amount and the second edge-shift amount.

### CLAIM OF PRIORITY

The present application claims priority from Japanese application serial No. P2005-343206, filed on Nov. 29, 2005, the content of which is hereby incorporated by reference into this application.

### BACKGROUND OF THE INVENTION

1. Field of the Invention

The present invention relates to an information recording technology for an optical disc apparatus. More particularly, the present invention is concerned with a technology for correcting recording pulse edges according to a prescribed recording strategy.

2. Description of the Related Art

Generally in an optical disc apparatus, OPC (Optimum Power Control) processing is performed prior to recording operation so that recording pulse with an optimum recording power according to a prescribed recording strategy can be generated. However, there are many cases when optimum recording pulse edge positions of the recording pulse vary because of the variation in the performance of optical disc apparatuses and the variation in optical discs. If a pulse edge position of recording pulse is not appropriate, the mark length or edge position of recording mark recorded on an optical disc deviates from an appropriate range, resulting in degraded quality of information reproduction such as jitter characteristic at the time of reproduction. For this reason, technologies for correcting pulse edge positions of recording pulse have previously been studied.

As examples related to the present invention, conventional technologies for edge correction of recording pulse used to record information on an optical disc are described in Japanese Patent Specification No. 2915098 and Japanese Patent Laid-open No. 2005-149610. Japanese Patent Specification No. 2915098 describes a technology for obtaining a desired recording mark length and a pulse interval of a reproduction signal in terms of combinations of recording medium and recording apparatus subject to recording and reproduction. This technology records diverse recording patterns in multiple regions on a recording medium at required timings; measures recording characteristic by reproducing the recorded data; creates a data table regarding the amount of adjustment of recording pulse interval from the measurement results; obtains sequentially the amount of adjustment of leading and trailing edges of pulse using the last multiple recording irradiation light pulse intervals obtained in previous conversions at each recording pulse interval based on the data table; and makes assignment for use as the recording irradiation light pulse interval. Japanese Patent Laid-open No. 2005-149610 describes a technology which obtains optimum values of the pulse width and pulse edge positions for each data length group with different relationships between the number of pulses and the data length; calculates an optimum recording power for test patterns through first tentative write processing to enable high-accuracy recording; calculates an optimum pulse width or optimum pulse edge positions for each data length group through second tentative write processing using the optimum recording power; and performs recording operation based on the optimum recording power and optimum recording waveform calculated in these tentative processing.

### SUMMARY OF THE INVENTION

The technology described in the above-mentioned Japanese Patent Specification No. 2915098 records diverse recording patterns at required timings; measures recording characteristic by reproducing the patterns; creates a data table regarding the amount of adjustment of the recording pulse interval based on the measurement results; and calculates the amount of adjustment of leading and trailing edges of pulse at each recording pulse interval based on the data table, as a series of correcting operations. It is assumed that this technology has a room for improvement in processing time to accommodate future recording technologies with increasing operating speed. The technology described in the above-mentioned Japanese Patent Laid-open No. 2005-149610 calculates an optimum recording power for test patterns through the first tentative write processing and then calculates an optimum pulse width or optimum pulse edge positions with reference to asymmetry β through the second tentative write processing using the optimum recording power. Therefore, this technology is prone to take a long processing time. Taking into account the situation of the above-mentioned conventional technologies, it is a subject of the present invention to enable edge correction of recording pulse in a short time in an optical disc apparatus to sufficiently accommodate future recording technologies with increasing operating speed. An object of the present invention is to solve the relevant problem and provide a convenient information recording technology which realizes a favorable recording quality in an optical disc apparatus.

To solve the above-mentioned problem, the present invention obtains as an optical disc apparatus an optimum recording power (meaning a recording power within an optimum range) of recording pulse through OPC processing according to a recording strategy with a first pulse timing; performs recording by use of recording pulse with the optimum recording power; measures a first edge-shift amount of recording mark from a reproduction signal; and performs edge correction of recording pulse based on the measurement results to form a second pulse timing of the recording strategy. The present invention subsequently performs recording by use of recording pulse with pulse width variations; measures a second edge-shift amount of recording mark from the reproduction signal; and obtains optimum edge positions (meaning edge positions within an optimum range) of recording pulse from two points through, for example, linear interpolation. The two points are the above-mentioned first edge-shift amount and the first pulse timing of the recording strategy, and the second edge-shift amount and a second pulse timing of the recording strategy.

In accordance with the present invention, it is possible to perform edge position correction of recording pulse having an optimum recording power in an optical disc apparatus in a short time, allowing rapid recording operation and accordingly improving the convenience of the apparatus.

### BRIEF DESCRIPTION OF THE DRAWINGS

These and other features, objects and advantages of the present invention will become more apparent from the following description when taken in conjunction with the accompanying drawings wherein:

FIG. 1 is a diagram showing an example configuration of an optical disc apparatus as one embodiment of the present invention;

FIG. 2 is a diagram showing OPC processing in the optical disc apparatus in FIG. 1;

FIG. 3A to FIG. 3C are diagrams showing combinations with which the edge-shift amount of recording mark in the optical disc apparatus in FIG. 1 can be measured;

FIG. 4A to FIG. 4C are diagrams showing an edge shift of recording mark in the optical disc apparatus in FIG. 1;

FIG. 5 is a diagram showing a method for obtaining optimum pulse edge positions of recording pulse in the optical disc apparatus in FIG. 1; and

FIG. 6 is a diagram showing the operation of edge correction of recording pulse in the optical disc apparatus in FIG. 1.

### DETAILED DESCRIPTION OF PREFERRED EMBODIMENTS

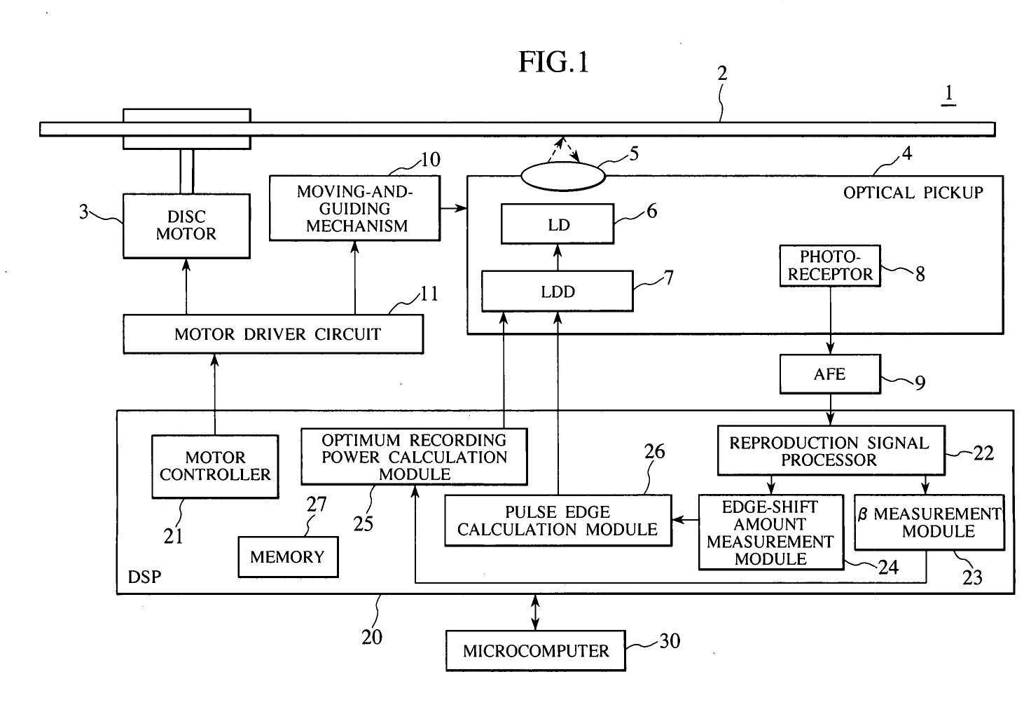

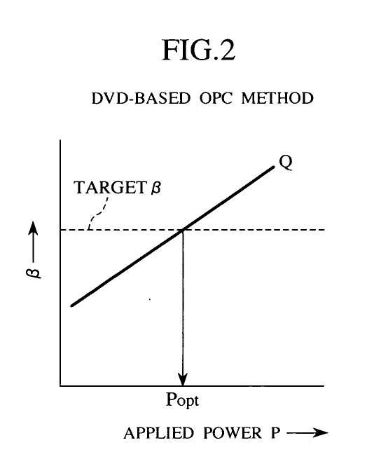

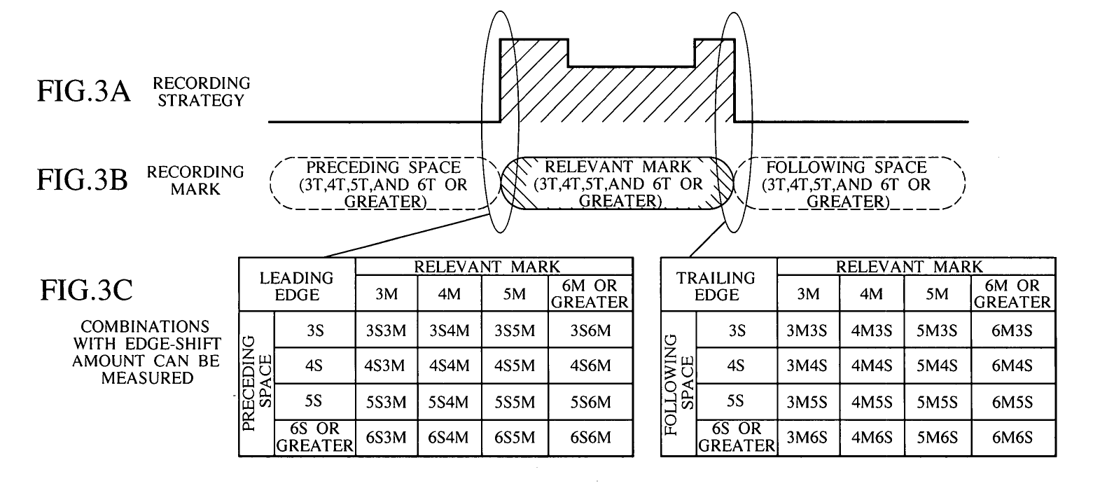

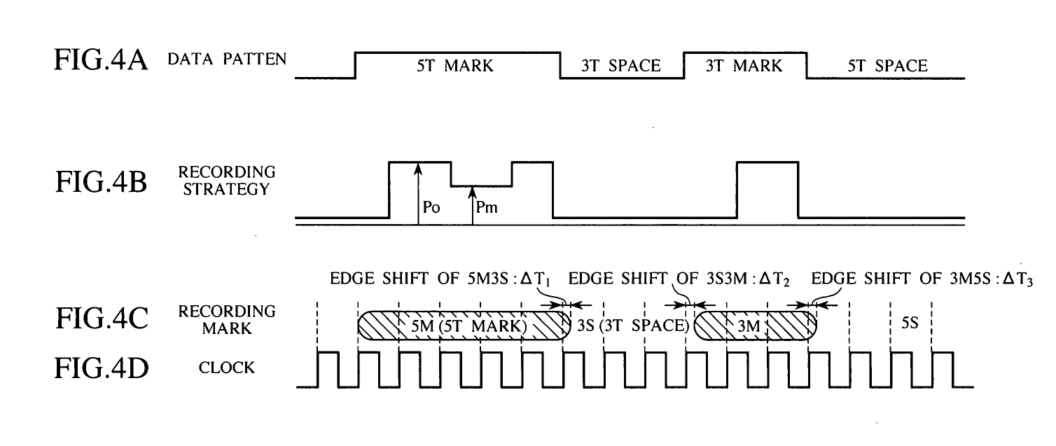

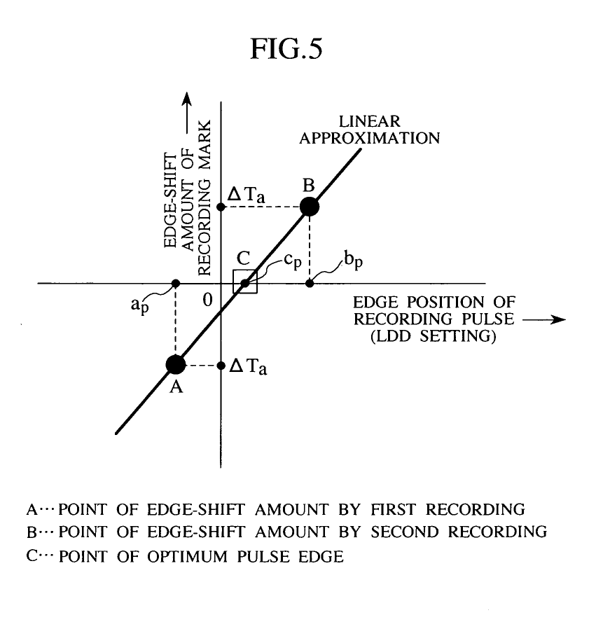

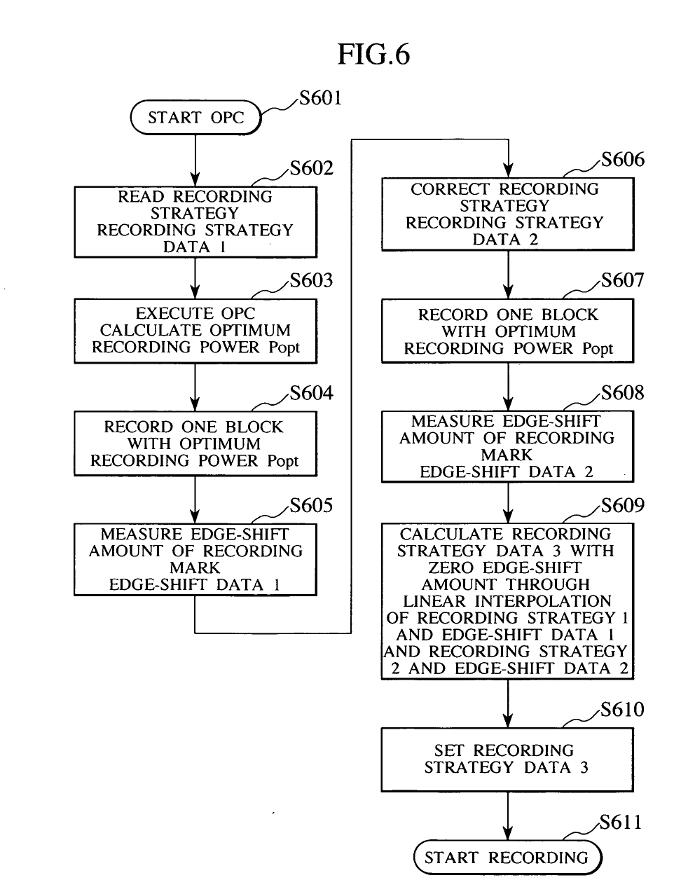

The following describes embodiments of the present invention using drawings. FIG. 1 to FIG. 6 are diagrams showing embodiments of the present invention. FIG. 1 is a diagram showing an example configuration of an optical disc apparatus as one embodiment of the present invention. FIG. 2 is a diagram showing OPC (Optimum Power Control) processing in the optical disc apparatus in FIG. 1. FIG. 3 is a diagram showing combinations with which the edge-shift amount of recording mark in the optical disc apparatus in FIG. 1 can be measured. FIG. 4 is a diagram showing an edge shift of recording mark in the optical disc apparatus in FIG. 1. FIG. 5 is a diagram showing a method for obtaining optimum pulse edge positions of recording pulse based on the measurement results of the edge-shift amount in the optical disc apparatus in FIG. 1. FIG. 6 is a diagram showing the operation of edge correction of recording pulse in the optical disc apparatus in FIG. 1.

In FIG. 1, reference numeral 1 denotes an optical disc apparatus as one embodiment of the present invention; 2, an optical disc such as a CD, DVD, or blue laser disc; 3, a disc motor which drives the revolution of the optical disc 2; 4, an optical pickup; 5, an objective lens; 6, a laser diode which emits laser light with a prescribed intensity for recording or reproduction; 7, a laser driver circuit which drives the laser diode 6; 8, a photoreceptor which receives reflected laser light from the recording surface (hereafter referred to as the optical disc surface) of the optical disc 2 through the objective lens 5, converts it to an electric signal, and outputs the signal; 9, an analog front-end which amplifies a signal from the photoreceptor 8 and performs other analog processing; 10, a moving-and-guiding mechanism, consisting of linear guide members (not shown), lead screw members (not shown), and a slide motor (not shown) driving the revolution of the lead screw members, which moves the optical pickup 4 into an approximate radius direction of the optical disc 2; 11, a motor driver circuit which drives the disc motor 3 and the slide motor 12; 20, a DSP (Digital Signal Processor); 21, a motor controller installed in the DSP30, which controls the motor driver circuit 11; 22, a reproduction signal processor installed in the DSP20, which processes a reproduction signal from the photoreceptor 8, as an RF signal, a tracking error signal, or a focus error signal; 23, a β measurement module installed in the DSP20, which measures the β value of recording mark recorded on the optical disc 2 from the reproduction signal; 25, an optimum recording power calculation module installed in the DSP20, which calculates an optimum recording power satisfying a target β value based on the β value measured in the β measurement module 23; 24, an edge-shift amount measurement module installed in the DSP20, which measures the edge-shift amount of recording mark from the reproduction signal of the information recorded on an optical disc with the optimum recording power obtained by the optimum recording power calculation module 25; 26, a pulse edge calculation module installed in the DSP20, which calculates optimum pulse edges of recording pulse based on pulse timings of the recording strategy and the above-mentioned edge-shift amount measured; 27, a memory installed in the DSP20 as a memory module, which memorizes pulse timings of the recording strategy and the above-mentioned edge-shift amount measured; and 30, a microcomputer as a control module, which controls the DSP20.

When the optical disc apparatus 1 performs recording operation, the microcomputer 30, prior to recording operation, controls at least the motor controller 21, the β measurement module 23, the optimum recording power calculation module 25, the edge-shift amount measurement module 24, and the pulse edge calculation module 26. Accordingly, calculations of an optimum recording power of recording pulse by OPC processing and of optimum pulse edges of recording pulse are performed, and recording pulse having optimally corrected pulse edges and the optimum recording power is output from the laser driver circuit 7 to the laser diode 6. Specifically, when the optical disc apparatus 1 performs recording operation, the microcomputer 30, prior to recording operation, reads a recording strategy (referred to as the recording strategy with the first pulse timing) corresponding to the optical disc 2 and instructs the optical disc apparatus 1 to perform OPC processing according to the read recording strategy, i.e., the recording strategy with the first pulse timing. In OPC processing, the microcomputer 30 instructs the laser driver circuit 7 to output recording pulse of the above-mentioned recording strategy with the first pulse timing to drive the laser diode 6 to perform recording of information on the optical disc 2. Subsequently, the microcomputer 30 instructs the β measurement module 23 to measure the β value of recording mark recorded on the optical disc 2 from a reproduction signal of the information and then instructs the optimum recording power calculation module 25 to calculate an optimum recording power of recording pulse based on the measured β value.

After the above-mentioned OPC processing, the microcomputer 30 instructs the laser driver circuit 7 to output recording pulse with the optimum recording power to perform recording on the optical disc 2 through light emission by the laser diode 6 and then instructs the edge-shift amount measurement module 24 to measure the edge-shift amount (first edge-shift amount) of the recorded recording mark. Then, the microcomputer 30 instructs the laser drier circuit 7 to perform edge correction of recording pulse of the above-mentioned recording strategy with the first pulse timing based on the first edge-shift amount of the measured recording mark to form a second pulse timing of the recording strategy, i.e., recognizes recording pulse as recording pulse of the recording strategy having the second pulse timing. Subsequently, the microcomputer 30 instructs the laser driver circuit 7 to output recording pulse with pulse width variations to perform recording on the optical disc 2 and then instructs the edge-shift amount measurement module 24 to measure the second edge-shift amount of recording mark from the reproduction signal. Subsequently, the microcomputer 30 instructs the pulse edge calculation module 26 to calculate, through linear interpolation, optimum pulse edge positions of recording pulse with a zero edge-shift amount from two points. The two points are the above-mentioned first edge-shift amount at the first pulse timing of the recording strategy and the above-mentioned second edge-shift amount at the second pulse timing of the recording strategy. Subsequently, the microcomputer 30 instructs the laser driver circuit 7 to output recording pulse with the above-mentioned optimum recording power and optimum pulse edges obtained. This makes the laser diode 6 to emit laser light to irradiate the optical disc 2 with laser light to perform recording of information. The microcomputer 30 instructs the memory 27 to memorize the first and second edge-shift amounts measured by the edge-shift amount measurement module 24 as well as the first and second pulse timings of the recording strategy.

The optimum recording power is a recording power within an optimum range, which means a recording power within a range which is sufficient to configure the present invention effectively. Similarly, an optimum pulse edge position of recording pulse is a pulse edge position within an optimum range of recording pulse, which means a pulse edge position within a range which is sufficient to configure the present invention effectively. The following explanation of components of the optical disc apparatus 1 in FIG. 1 uses the same reference numerals as those used in FIG. 1.

FIG. 2 is a diagram showing OPC processing in the optical disc apparatus in FIG. 1. In FIG. 2, the horizontal axis is assigned the power (hereafter referred to as the recording power) applied to the recording surface of the optical disc 2 to measure the β value of recording mark in OPC processing, and the vertical axis is assigned the β value of recording mark on the recording surface of the optical disc 2. In OPC processing, laser light with recording power variations is emitted from the laser diode 6 to the recording surface of the optical disc 2, and then the β value of recording mark corresponding to each individual recording power is measured by the β measurement module from a reproduction signal by reflected laser light to obtain characteristic curve Q in FIG. 2. Subsequently, a target β value is set and, based on the characteristic curve Q, an optimum recording power of laser light corresponding to the target β value, Pₒₚₜ, is set.

FIG. 3 is a diagram showing combinations with which the edge-shift amount of recording mark in the optical disc apparatus 1 in FIG. 1 can be measured. FIG. 3A is a diagram showing a recording strategy. FIG. 3B is a diagram showing a recording mark recorded on the optical disc 2. FIG. 3C is a table showing combinations with which the edge-shift amount of recording mark (the amount by which an edge of recording mark shifts from the clock reference position) can be measured. In the recording strategy in FIG. 3A, the horizontal axis indicates the pulse timing and the vertical axis indicates the recording power level. The shape of the recording strategy corresponds to the recording pulse. With a DVD-based optical disc, for example, the recording mark length and the space length (time length between recording marks) are 3T to 11T and 14T when the clock period is T. FIG. 3 is a diagram showing an example with the DVD-based optical disc.

In FIG. 3, 3M, 4M, 5M, and 6M or greater respectively indicate a recording mark with a mark length of 3T, 4T, 5T, and 6T or greater; and 3S, 4S, 5S, and 6S or greater respectively indicate a space with a space length of 3T, 4T, 5T, and 6T or greater. The edge-shift amount measurement module 24 makes it possible to measure the edge-shift amount between the leading/trailing edge of each of recording marks 3M, 4M, 5M, and 6M or greater and the spaces 3S, 4S, 5S, and 6S or greater. For example, the edge-shift amount can be measured between four different spaces (the spaces 3S, 4S, 5S, and 6S or greater) preceding relevant recording mark 3M and the leading edge of the relevant recording mark 3M. Similarly, the edge-shift amount can be measured between the trailing edge of the relevant recording mark 3M and four different spaces (the spaces 3S, 4S, 5S, and 6S or greater) following the relevant recording mark 3M. In the table in FIG. 3C, 3S3M indicates a combination of the space 3S preceding recording mark 3M and the leading edge of the recording mark 3M; 4S3M indicates a combination of the space 4S preceding recording mark 3M and the leading edge of the recording mark 3M; 5S3M indicates a combination of the space 5S preceding recording mark 3M and the leading edge of the recording mark 3M; 6S3M indicates a combination of the space 6S or greater preceding recording mark 3M and the leading edge of the recording mark 3M; 3M3S indicates a combination of the trailing edge of recording mark 3M and the space 3S following the recording mark 3M; 3M4S indicates a combination of the trailing edge of recording mark 3M and the space 4S following the recording mark 3M; 3M5S indicates a combination of the trailing edge of recording mark 3M and the space 5S following the recording mark 3M; 3M6S indicates a combination of the trailing edge of recording mark 3M and the space 6S or greater following the recording mark 3M. The above-mentioned combinations also apply to recording marks 4M, 5M, and 6M or greater. Specifically with the optical disc apparatus 1 in FIG. 1, when recording information on a DVD-based optical disc, the measurement of the edge-shift amount of recording mark is performed by the edge-shift amount measurement module 24 in terms of a total of 32 different combinations shown in the table in FIG. 3C.

FIG. 4 is a diagram showing an edge shift of recording mark in the optical disc apparatus in FIG. 1. FIG. 4A is a diagram showing a data pattern corresponding to recording strategy; FIG. 4B, recording strategy; FIG. 4C, a recording mark; and FIG. 4D, the clock. In FIG. 4, recording mark 5M has a shift from the clock reference position by time ΔT₁, i.e., an edge shift of time ΔT₁ has occurred with combination 5M3S, a combination of the trailing edge of recording mark 5M and the space 3S following the recording mark 5M; recording mark 3M has a shift from the clock reference position by time ΔT₂, i.e., an edge shift of time ΔT₂ has occurred with combination 3S3M, a combination of the leading edge of recording mark 3M and the space 5S preceding the recording mark 3M; and the recording mark 3M has a shift from the clock reference position by time ΔT₃, i.e., an edge shift of time ΔT₃ has occurred with combination 3M5S, a combination of the trailing edge of the recording mark 3M and the space 5S following the recording mark 3M. These edge-shift amounts are measured by the edge-shift amount measurement module 24 in the optical disc apparatus 1 in FIG. 1. The edge-shift amount measurement module 24 outputs, as a measurement result signal, a signal corresponding to the edge-shift amount (i.e., first edge-shift amount) of recording mark, which is measured first after the optimum recording power Pₒₚₜ has been calculated by the above-mentioned OPC processing. If a signal corresponding to an edge-shift amount exceeding a reference value, for example about ±5% of the clock, is output as the measurement result signal, the microcomputer 30 instructs the laser driver circuit 7 to perform edge correction of recording pulse of the recording strategy with the first pulse timing based on the first edge-shift amount, thereby forming a second pulse timing of the recording strategy, i.e., recognizing recording pulse as recording pulse of the recording strategy having the second pulse timing. Then, the microcomputer 30 instructs the laser driver circuit 7 to output recording pulse with pulse width variations to perform recording on the optical disc 2. The edge-shift amount measurement module 24 measures the second edge-shift amount of recording mark from the reproduction signal. The pulse edge calculation module 26 calculates, through linear interpolation, optimum pulse edge positions of recording pulse with a zero edge-shift amount from two points. The two points are the above-mentioned first edge-shift amount at the first pulse timing of the recording strategy and the above-mentioned second edge-shift amount at the second pulse timing of the recording strategy. On the other hand, if the first edge-shift amount of recording mark is small, not exceeding the above-mentioned reference value, the above-mentioned measurement result signal is output from the edge-shift amount measurement module 24 but optimum pulse edge positions of recording pulse are not calculated by the pulse edge calculation module 26.

FIG. 5 is a diagram showing a method for obtaining appropriate pulse edge positions of recording pulse in the optical disc apparatus 1 in FIG. 1.

In FIG. 5, the horizontal axis is assigned the edge position of recording pulse corresponding to a pulse timing of the recording strategy set in the laser driver circuit 7, and the vertical axis is assigned the edge-shift amount of recording mark recorded on the optical disc 2. A is a point which indicates the first edge-shift amount ΔTₐ (the edge-shift amount of recording mark, measured first by the edge-shift amount measurement module 24 after the optimum recording power Pₒₚₜ has been calculated by OPC processing) of recording mark at the first pulse timing (edge position aₚ of recording pulse) of the recording strategy. (In FIG. 5, this point is referred to as the point of edge-shift amount by first recording.) B is a point which indicates the second edge-shift amount ΔT_{b} (the edge-shift amount of recording mark when recorded by use of recording pulse with pulse width variations) of recording mark at the second pulse timing (edge position bₚ of recording pulse) of the recording strategy. (In FIG. 5, this point is referred to as the point of edge-shift amount by second recording.) C is a point having a zero edge-shift amount (edge position Cₚ of recording pulse: optimum pulse edge position) when linear interpolation between A and B is performed. (In FIG. 5, this point is referred to as the point of optimum pulse edge.) The pulse edge calculation module 26 performs calculation of linear interpolation based on the above-mentioned first pulse timing of the recording strategy, above-mentioned first edge-shift amount, above-mentioned second pulse timing of the recording strategy, and above-mentioned second edge-shift amount to obtain an optimum pulse edge position Cₚ of recording pulse. The laser driver circuit 7 corrects edge positions of recording pulse to the optimum pulse edge positions and then outputs recording pulse with an optimum recording power and optimum pulse edges, thereby making the laser diode 6 emit laser light.

FIG. 6 is a diagram showing the operation of edge correction of recording pulse in the optical disc apparatus in FIG. 1. In FIG. 6, (1) when the optical disc apparatus 1 performs recording, the microcomputer 30 issues an instruction for OPC processing before the recording operation (Step S601). (2) The microcomputer 30 reads a recording strategy (recording strategy with the first pulse timing) corresponding to the optical disc 2 (hereafter referred to as the recording strategy data 1) (Step S602). The microcomputer 30 instructs the memory 27 to memorize the read recording strategy 1. (3) Then, the microcomputer 30 executes OPC processing based on the recording strategy data 1 (Step S603). Specifically, the microcomputer 30 instructs the laser driver circuit 7 to output recording pulse of the recording strategy data 1 to drive the laser diode 6 to perform recording of information on the optical disc 2; instructs the β measurement module 23 to measure the β value of recording mark recorded on the optical disc 2 from the reproduction signal; and instructs the optimum recording power calculation module 25 to calculate the optimum recording power Pₒₚₜ of recording pulse based on the measured β value. (4) After the above-mentioned OPC processing, the microcomputer 30 instructs the laser driver circuit 7 to output recording pulse with the optimum recording power Pₒₚₜ to make the laser diode 6 emit laser light to perform recording of one block on the optical disc 2 (Step 8604). (5) The microcomputer 30 instructs the edge-shift amount measurement module 24 to measure the edge-shift amount (first edge-shift amount) of recording mark recorded in the above-mentioned Step S604 in terms of 32 different combinations (FIG. 3) and then instructs the memory 27 to memorize the measurement results as edge-shift data 1 (Step S605).

(6) The microcomputer 30 performs correction of the recording strategy based on the above-mentioned edge-shift data 1 to form recording strategy 2 (Step S606). Specifically, if the first edge-shift amount of recording mark measured in the above-mentioned Step S605 exceeds a reference value, for example about ±5% of the clock, the microcomputer 30 instructs the laser driver circuit 7 to perform edge correction of recording pulse in the above-mentioned recording strategy data 1 based on the first edge-shift amount to form recording strategy data 2, and recognizes recording pulse as recording pulse of the recording strategy (recording strategy data 2) having the second pulse timing. The microcomputer 30 instructs the memory 27 to memorize the above-mentioned recording strategy data 2 formed. (7) Subsequently, the microcomputer 30 instructs the laser driver circuit 7 to output recording pulse with pulse width variations to perform recording of one block on the optical disc 2 (Step S607). (8) The microcomputer 30 instructs the edge-shift amount measurement module 24 to measure the edge-shift amount (second edge-shift amount) of recording mark recorded in the above-mentioned Step S607 in terms of 32 different combinations (FIG. 3) and then instructs the memory 27 to memorize the measurement results as edge-shift data 2 (Step S608). (9) The microcomputer 30 instructs the pulse edge calculation module 26 to calculate optimum pulse edge positions of recording pulse with a zero edge-shift amount through linear interpolation for two points, point A (in FIG. 5) being defined by the first edge-shift amount at the first pulse timing of the recording strategy, i.e., the recording strategy data 1 and the edge-shift data 1 and point B (in FIG. 5) being defined by the second edge-shift amount at the second pulse timing of the recording strategy, i.e., the recording strategy data 2 and the edge-shift data 2; and to calculate a recording strategy for instructing the laser driver circuit 7 to output recording pulse with optimum pulse edge positions and optimum recording power Pₒₚₜ, as recording strategy data 3 (Step S609). (10) The microcomputer 30 sets the above-mentioned recording strategy data 3 obtained for recording of information (Step S610). (11) After completion of the edge correction processing of recording pulse in the above-mentioned Steps S601 to S610, the microcomputer 30 instructs the optical disc apparatus 1 to start recording of information on the optical disc 2 by laser emission based on the recording strategy data 3 (Step S611). A series of the above-mentioned Steps S601 to S611 is performed automatically by the microcomputer 30 in accordance with a program memorized in a memory module in the optical disc apparatus 1, such as the memory 27.

The optical disc apparatus 1 according to the above-mentioned embodiment makes it possible to perform edge position correction of recording pulse having the optimum recording power Pₒₚₜ in a short time, thereby enabling rapid recording operation and improving the convenience of the apparatus.

Although the above-mentioned embodiment obtains optimum edge positions of recording pulse through linear interpolation, the present invention is not limited to this method. Optimum edge positions of recording pulse may be obtained by any kind of technology which can obtain the same operation and effect as the linear interpolation or more. Although the above-mentioned embodiment is configured so that the microcomputer 30 is installed as a control module separately from the DSP20, the present invention is not limited to this configuration neither. The microcomputer may be integrated in the DSP.

While we have shown and described several embodiments in accordance with our invention, it should be understood that disclosed embodiments are susceptible to changes and modifications without departing from the scope of the invention. Therefore, we do not intend to be bound by the details shown and described herein but intend to cover all such changes and modifications as fall within the ambit of the appended claims.

What is claimed is:

1. An optical disc apparatus which records and reproduces information by irradiating an optical disc with laser light, comprising:
a laser diode which emits the laser light;
a laser driver circuit which outputs recording pulse according to a prescribed recording strategy to drive the laser diode;
a β measurement module to measure the β value of recording mark recorded on the optical disc from a reproduction signal based on reflected laser light from the optical disc;
an optimum recording power calculation module to calculate an optimum recording power satisfying a target β value based on the β value measured;
an edge-shift amount measurement module to measure the edge-shift amount of recording mark from a reproduction signal of the information recorded on an optical disc with the optimum recording power obtained;
a memory module to memorize pulse timings of the recording strategy and the measured edge-shift amount;
a pulse edge calculation module to calculate optimum pulse edges of recording pulse based on pulse timings of the recording strategy and the edge-shift amount measured; and
a control module to control the laser driver circuit, the β measurement module, the edge-shift amount measurement module, the memory module, and the pulse edge calculation module; perform edge correction of recording pulse based on the measurement results of the edge-shift amount; and set pulse timings of the recording strategy based on the calculation results of the optimum pulse edges;
wherein the laser diode is driven by use of recording pulse with the optimum recording power and optimum pulse edges obtained to perform recording of information.

2. The optical disc apparatus as defined in claim 1, wherein the control module controls the laser driver circuit so as to perform recording with at least two variations of recording pulse width with the optimum recording power; the edge-shift amount measurement module measures two edge-shift amounts of recording mark recorded with each of the two variations of recording pulse width from a reproduction signal; and the pulse edge calculation module calculates optimum pulse edges based on the two edge-shift amounts measured.

3. The optical disc apparatus as defined in claim 1, wherein the pulse edge calculation module performs linear interpolation of the two edge-shift amounts of recording mark, measured by the edge-shift amount measurement module, and recognizes pulse edges with an edge-shift amount of zero as the optimum pulse edges.

4. The optical disc apparatus as defined in claim 1, wherein the pulse edge calculation module calculates optimum pulse edges of recording pulse if the edge-shift amount of recording mark measured by the edge-shift amount measurement module exceeds a reference value.

5. An information recording method for recording information by irradiating an optical disc with laser light, comprising:
a first step of measuring the β value of recording mark recorded on an optical disc from a reproduction signal of information recorded on the optical disc with a recording strategy with a first pulse timing and then calculating an optimum recording power of recording pulse based on the measured β value;
a second step of performing recording on an optical disc with laser light by use of recording pulse having the optimum recording power and a first pulse width obtained and then measuring a first edge-shift amount of recording mark from a reproduction signal;
a third step of correcting recording pulse edges of the recording strategy by the first edge-shift amount measured and then forming a second pulse timing of the recording strategy;
a fourth step of memorizing the first edge-shift amount of recording mark measured and the first and second pulse timings of the recording strategy;
a fifth step of performing recording on an optical disc with laser light by use of recording pulse having the optimum recording power and a second pulse width obtained and then measuring a second edge-shift amount of recording mark from a reproduction signal;
a sixth step of calculating optimum pulse edges of recording pulse based on two-point information: the first edge-shift amount and the first pulse timing of the recording strategy; and the second edge-shift amount and the second pulse timing of the recording strategy;
a seventh step of outputting recording pulse with the optimum recording power obtained in the first step and the optimum pulse edges obtained in the sixth step; and
an eighth step of driving a laser diode with the recording pulse;
wherein laser light is generated by use of recording pulse with the optimum recording power and optimum pulse edges to perform recording of information on an optical disc.

6. The information recording method as defined in claim 5, wherein the third step, if the first edge-shift amount exceeds a preset reference value as a result of discrimination of the first edge-shift amount measured, performs edge correction of recording pulse of the recording strategy to form a second pulse timing of the recording strategy.

7. The information recording method as defined in claim 5, wherein the sixth step calculates optimum pulse edges of the recording pulse through linear interpolation for the two-point information.

8. The information recording method as defined in claim 5, wherein the second step measures a time difference of the leading edge of recording mark from the clock reference position and a time difference of the trailing edge of recording mark from the clock reference position as the first edge-shift amount; and the fifth step measures a time difference of the leading edge of recording mark from the clock reference position and a time difference of the trailing edge of recording mark from the clock reference position as the second edge-shift amount.

9. An optical disc apparatus which records and reproduces information by irradiating an optical disc with laser light, comprising:
a laser diode which emits the laser light;
a laser driver circuit which outputs recording pulse according to a prescribed recording strategy to drive the laser diode; and
a β measurement module to measure the 1 value of recording mark recorded on an optical disc from a reproduction signal based on reflected laser light from the optical disc;
wherein the laser diode is driven by use of recording pulse with an optimum recording power and optimum pulse edges to perform recording of information.
